(19) United States
(12) Patent Application Publication
(10) Pub. No.: US 2015/0045485 A1
(43) Pub. Date: Feb. 12, 2015

(54) POLYETHYLENE-BASED RESIN COMPOSITION FOR CONTAINER LID, AND CONTAINER LID

(71) Applicant: Japan Polyethylene Corporation, Chiyoda-ku (JP)

(72) Inventors: Daisuke Tsutimoto, Kanagawa (JP); Hiroya Yamamoto, Kanagawa (JP); Kunihiko Ibayashi, Kanagawa (JP); Keiichi Yoshimoto, Kanagawa (JP)

(73) Assignee: Japan Polyethylene Corporation, Chiyoda-ku (JP)

(21) Appl. No.: 14/376,543

(22) PCT Filed: Feb. 6, 2013
(86) PCT No.: PCT/JP2013/052682

§ 371 Date: Aug. 4, 2014

(30) Foreign Application Priority Data
Feb. 7, 2012 (JP) 2012-023581

(51) Int. Cl. C08L 23/06

(52) U.S. Cl. CPC C08L 23/06; C08L 2205/025
USPC 524/151; 525/186

(57) ABSTRACT

The present invention is to provide a polyethylene resin composition for container closures and a container closure exhibiting excellent mouldability, high flowability, excellent balance between rigidity and impact resistance, excellent stress cracking resistance, excellent sliding property, low odour level, harmlessness for food, decreased elongation at high temperatures and sterilizability by electron beam upon attachment of the closure to a container. The present invention is a polyethylene resin composition for a container closure, this composition having, relative to 100 parts by weight of a polyethylene resin, 0.01 to 0.50 parts by weight of a hindered amine compound and having the following properties (a) to (f):
(a) a melt flow rate (MFR) of 0.5 to 10 g/10 min, a melt flow rate (HLMFR) of 100 to 500 g/10 min and HLMFR/MFR of 50 to 200;
(b) a density of 0.956 to 0.980 g/cm³;
(c) a flexural modulus of an injection moulding test specimen of 990 to 2000 MPa;
(d) a constant strain ESCR of an injection moulding test specimen of 10 to 400 hours;
(e) a tensile elongation at break of 190% or less; and
(f) a melt viscosity of 470 Pa·s or less.

### TECHNICAL FIELD

The present invention relates to a polyethylene resin composition for container closures and a container closure, specifically to a polyethylene resin composition used for moulding of closures for containers of liquid such as soft drinks and a container closure obtained therefrom, and more specifically the present invention relates to a polyethylene resin composition for container closures which has excellent mouldability, has high flowability, has excellent balance between rigidity and impact resistance, has excellent stress cracking resistance, has excellent sliding property, has low odour, is harmless for food, has decreased elongation at high temperatures and is sterilizable by electron beam upon attachment thereof to a container, and to a container closure.

### BACKGROUND ART

Polyethylene terephthalate containers (hereinafter also referred to as PET bottles) have been conventionally used for containing soft drink and the like and polyolefin container closures are recently starting to be used as closures for those containers.

There has been approaches for preparing polyolefin container closures with shortened moulding cycles and improved production efficiency by injection moulding and compression moulding of polyolefins with high flowability. From the economical point of view, the container closures are required to have low wall thickness, and therefore there are needs for materials having high rigidity in order to avoid deformation due to inner pressure and resulting leakage of contents.

For example, polyolefin materials disclosed in Patent Documents 1 to 3 have been proposed. However, the polyethylene composition disclosed in Patent Document 1, in spite of preferable stress cracking resistance thereof, has insufficient high-cycle mouldability and has not been rendered to be sufficiently rigid. Although polyethylene resin compositions disclosed in Patent Documents 2 and 3 could improve stress cracking resistance of containers and container closures, containers have been required to have further excellent rigidity for the purpose of heating and there is a further need for materials having mouldability at high speed.

Accordingly, the present applicant proposed a polyethylene resin for container closures disclosed in Patent Document 4. The polyethylene resin could provide excellent mouldability, high flowability, excellent balance between rigidity and impact resistance, excellent stress cracking resistance and excellent sliding property, allowed relatively effortless cutting and could provide improved mouldability at high speed.

Meanwhile, in the procedures for producing food containers such as PET bottles, filling the containers with contents and attaching container closures to the containers, sterilization of the containers and the like is crucial. Sterilization is usually carried out with chemicals typically including hydrogen peroxide. Alternative to the use of chemicals, sterilization by electron beam has been studied. Sterilization by electron beam has been attracting an attention because the technique obviates use of chemicals and as a result obviates the cost for the chemicals and also obviates the step for rinsing away the chemicals.

However, subjecting polyolefin materials to electron beam sterilization has issues of possible cleavage and oxidation of molecular chains of polyolefin molecules due to electron beams, resulting in development in degradation and deterioration and reduced mechanical properties such as elongation and impact resistance, and alteration of various stabilizers and modifiers generally added for the purpose of prevention of oxidation and the like, resulting in discoloration and odour.

As a technique for improving radiation resistance of polyolefin resins, Patent Documents 5 to 11 disclose resin compositions containing polyolefin resins and hindered amine compounds. Despite radiation resistance of polyolefin resins may be improved in some extent, these Patent Documents do not disclose application thereof for container closures and thus do not provide satisfactory properties so as to be used for container closures.

Patent Document 12 discloses a polymer composition for bottle screw caps containing at least one stabilizer selected from a neutralizing agent, an antioxidant for short term, an antioxidant for long term and an UV stabilizer. However, the polymer composition does not have sufficient balance between flowability, rigidity and performance for long term and thus does not satisfactorily fulfil various performance requirements so as to be used for container closures.

No polyethylene resin composition for container closures has been known which does not allow developed degradation and deterioration after electron beam irradiation upon attachment of closures to containers, does not allow reduction in mechanical properties such as elongation and impact resistance and produces less discoloration and odour, and thus there has been a need for further improvements.

### CITATION LIST

### Patent Literature

Patent Document 1: Japanese Patent Application Laid-open No. S58-103542
Patent Document 2: Japanese Patent Application Laid-open No. 2000-248125
Patent Document 3: Japanese Patent Application Laid-open No. 2002-60559
Patent Document 4: Japanese Patent Application Laid-open No. 2005-320526
Patent Document 5: Japanese Patent Application Laid-open No. H2-153953
Patent Document 6: Japanese Patent Application Laid-open No. H2-153954
Patent Document 7: Japanese Patent Application Laid-open No. H4-359040
Patent Document 8: Japanese Patent Application Laid-open No. H7-188472
Patent Document 9: Japanese Patent Application Laid-open No. 2000-136272
Patent Document 10: Japanese Patent Application Laid-open No. 2000-313813
Patent Document 11: Japanese Patent Application Laid-open No. 2007-231036
Patent Document 12: Japanese Translation of PCT Application No. 2002-531622

### SUMMARY OF INVENTION

### Technical Problem

With the foregoing in view, it is an object of the present invention to provide a material suitable for container closures of beverage containers such as PET bottles sterilizable particularly by electron beams, which material is a polyethylene resin that has excellent mouldability, has high flowability, has excellent balance between rigidity and impact resistance, has excellent stress cracking resistance, has excellent sliding property, has decreased elongation at high temperatures, does not undergo discoloration due to oxidation deterioration, is low volatile and thus has low odour and has excellent mouldability at high speed.

It is also an object of the present invention to provide a container closure which does not allow developed degradation and deterioration, does not allow reduction in mechanical properties such as elongation and impact resistance and has decreased production of discoloration and odour even after electron beam irradiation.

### Solution to Problem

The present inventors have carried out exhaustive studies in order to achieve the above objectives and develop a material which is a polyethylene resin composition for container closures having properties such as mouldability, high flowability, rigidity and stress cracking resistance, does not allow developed degradation and deterioration, does not allow reduction in mechanical properties such as elongation and impact resistance and has decreased generation of discoloration and odour even after electron beam irradiation, and as a result has found that a polyethylene resin for container closures fulfilling all the properties can be obtained by adding to a polyethylene resin a specific amount of a hindered amine compound and conferring specific resin properties, thereby achieving the present invention.

Thus the first invention of the present invention provides a polyethylene resin composition for a container closure,

the composition comprising 0.01 to 0.50 parts by weight of a hindered amine compound relative to 100 parts by weight of a polyethylene resin, and having the following properties (a) to (f):

(a) a melt flow rate measured at a temperature of 190° C. under a load of 2.16 kg (MFR), of 0.5 to 10 g/10 min, a melt flow rate measured at a temperature of 190° C. under a load of 21.6 kg (HLMFR), of 100 to 500 g/10 min and HLMFR/MFR of 50 to 200;

(b) a density of 0.956 to 0.980 g/cm³;

(c) a flexural modulus of an injection moulding test specimen of 990 to 2000 MPa;

(d) a constant strain ESCR of an injection moulding test specimen of 10 to 400 hours;

(e) a tensile elongation at break of 190% or less; and

(f) a melt viscosity as measured on a capillary rheometer at 200° C. and a shear rate of 200 sec⁻¹ of 470 Pa·s or less.

The second invention of the present invention provides the polyethylene resin composition for a container closure according to the first invention, which further has the following properties (g) to (i):

(g) a hydrocarbon volatile matter content of 100 ppm or less;

(h) a coefficient of static friction of 0.40 or less; and

(i) a variation (ΔYI) in chromaticity (YI value) of 2 or less before and after irradiating a sheet-shaped test specimen having a thickness of 2 mm with an electron beam at an absorbed dose of 30 kGy.

The third invention of the present invention provides the polyethylene resin composition for a container closure according to the first or second invention, wherein the hindered amine compound has a molecular weight of 500 or more.

The fourth invention of the present invention provides the polyethylene resin composition for a container closure according to the first invention, wherein the polyethylene resin contains: 10 to 45% by weight of an ethylene polymer (A) having a HLMFR of 0.1 to 10 g/10 min and a density of 0.926 to 0.955 g/cm³; and 55 to 90% by weight (A+B=100% by weight) of an ethylene polymer (B) having a MFR of 25 g/10 min or more and a density of 0.961 to 0.980 g/cm³.

The fifth invention of the present invention provides the polyethylene resin composition for a container closure according to the first invention, which further contains 0.01 to 0.50 parts by weight of a phosphorous compound relative to 100 parts by weight of the polyethylene resin.

The sixth invention of the present invention provides the polyethylene resin composition for a container closure according to the first invention, wherein the hindered amine compound is poly[{6-(1,1,3,3-tetramethylbutyl)amino-1,3,5-triazine-2,4-diyl}{(2,2,6,6-tetramethyl-4-piperidyl)imino}hexamethylene{(2,2,6,6-tetramethyl-4-piperidyl)imino}]polycondensate and/or dimethyl succinate-1-(2-hydroxyethyl)-4-hydroxy-2,2,6,6-tetramethylpiperidine polycondensate.

The seventh invention of the present invention provides a container closure moulded in use of the polyethylene resin composition of any of the first to sixth inventions.

### Advantageous Effects of Invention

The polyethylene resin composition for a container closure of the present invention contains, relative to a polyethylene resin, a specific amount of a hindered amine compound and is rendered to have specific resin properties, and thus has properties such that it has excellent mouldability, has high flowability, has excellent balance between rigidity and impact resistance, has excellent stress cracking resistance, has excellent slipping property, has low odour, is harmless for food and has decreased elongation at high temperatures.

Particularly the composition contains the hindered amine compound and thus is a suitable material for container closures for beverage containers such as PET bottles which does not allow developed degradation and deterioration, does not allow reduction in physical properties such as elongation and impact resistance and has decreased production of discoloration and odour even after electron beam irradiation, and can provide a container closure which has high rigidity and can be opened easily. Furthermore the composition has excellent mouldability at high speed and has a low hydrocarbon volatile matter content that may confer odour to the content, and thus can provide a material suitable for container closures and a container closure.

### BRIEF DESCRIPTION OF DRAWINGS

FIG. 1 is a front view including a partial section view of a container closure which is a moulded product of a polyethylene resin composition for a container closure of the present invention.

### DESCRIPTION OF EMBODIMENTS

1. Polyethylene Resin Composition for Container Closures

### (1) Polyethylene Resin

The polyethylene resin in the present invention can be obtained by polymerizing mainly ethylene using various well known catalysts such as Ziegler catalysts, Phillips catalysts and metallocene catalysts. The polyethylene resin generally can be obtained by polymerization using, as a polymerization catalyst, a Ziegler catalyst containing a transition metal compound such as titanium and zirconium or a magnesium compound; a Phillips catalyst typically including a chromium oxide catalyst; and a metallocene catalyst which is a transition metal compound such as zirconium, hafnium and titanium containing at least one cyclopentadienyl or substituted cyclopentadienyl group. Upon polymerization, ethylene may be homo-polymerized or ethylene and one or more comonomers selected from α-olefins having 3 to 18 carbon atoms may be co-polymerized so as to obtain desired MFR, density and the like. Typical α-olefins to be co-polymerized may include, for example, propylene, 1-butene, 1-hexene, 1-octene, 4-methyl-1-pentene and the like. The polyethylene resin of the present invention may be solely an ethylene homopolymer or an ethylene/α-olefin copolymer or may be an appropriate mixture thereof.

### (2) Hindered Amine Compound

The polyethylene resin composition for a container closure of the present invention contains a hindered amine compound in order to prevent deterioration due to electron beam irradiation, reduction in mechanical properties such as impact resistance and production of discoloration and odour.

The amount of the hindered amine compound is, relative to 100 parts by weight of the polyethylene resin, 0.01 to 0.50 parts by weight. The amount is preferably 0.02 to 0.30 parts by weight and more preferably 0.03 to 0.15 parts by weight. When the amount of the hindered amine compound is less than 0.01 parts by weight, the polyethylene resin may be deteriorated by electron beam irradiation, may produce impaired mechanical properties such as impact resistance and may have discoloration and odour. On the other hand, when the amount is more than 0.50 parts by weight, the hindered amine compound bleeds out on the surface of moulded articles, resulting in defects in appearance.

The hindered amine compound is not particularly limited as far as it can achieve the purpose of the present invention and may be one or more than one in combination selected from the compounds well known and common in the art. The hindered amine compound is an amine compound having a restrained conformation and may include so-called hindered amine light stabilizers (hereinafter also referred to as HALS). Mention may be made to the compounds disclosed in, for example, Japanese Patent Application Laid-open No. H7-286052, particularly 2,2,6,6-tetraalkylpiperidine derivatives having a substituent at the 4-position and having a molecular weight of 250 or more, among which the compounds having methyl groups substituting all hydrogen atoms on carbon atoms at the 2- and 6-positions of piperidine are preferred.

Particularly preferable hindered amine light stabilizers may include poly[{6-(1,1,3,3-tetramethylbutyl)amino-1,3,5-triazine-2,4-diyl)}{(2,2,6,6-tetramethyl-4-piperidyl)imino}hexamethylene{(2,2,6,6-tetramethyl-4-piperidyl)imino}]polycondensate (BASF, Chimassorb 944, CAS No. 71878-19-8, molecular weight: 2000 to 3100) and dimethyl succinate-1-(2-hydroxyethyl)-4-hydroxy-2,2,6,6-tetramethylpiperidine polycondensate (BASF, Tinuvin 622, CAS No. 65447-77-0, molecular weight: 3100 to 4000).

Specific examples of the hindered amine compound may include, for example,
polycondensates of dimethyl succinate and 1-(2-hydroxyethyl)-4-hydroxy-2,2,6,6-tetramethylpiperidine;
poly[[6-(1,1,3,3-tetramethylbutyl)imino-1,3,5-triazine-2,4-diyl][(2,2,6,6-tetramethyl-4-4-piperidyl)imino]hexamethylene[(2,2,6,6-tetramethyl-4-piperidyl)imino]];
2-(3,5-di-t-butyl-4-hydroxybenzyl)-2-n-butyl malonate bis(1,2,2,6,6-pentamethyl-4-piperidyl)ester;
tetrakis(2,2,6,6-tetramethyl-4-piperidyl)-1,2,3,4-butanetetracarboxylate;
polycondensates of bis(2,2,6,6-tetramethyl-4-piperidyl)sebacate, N,N′-bis(2,2,6,6-tetramethyl-4-piperidyl)hexamethylenediamine and 1,2-dibromoethane;
poly[(N,N′-bis(2,2,6,6-tetramethyl-4-piperidyl)hexamethylenediamine)-(4-morpholino-1,3,5-triazine-2,6-diyl)];
1,1′-(1,2-ethanediyl)-bis(3,3,5,5-tetramethylpiperadinone);
tris(2,2,6,6-tetramethyl-4-piperidyl)-dodecyl-1,2,3,4-butanetetracarboxylate;
tris(1,2,2,6,6-pentamethyl-4-piperidyl)-dodecyl-1,2,3,4-butane tetracarboxylate;
bis(1,2,2,6,6-pentamethyl-4-piperidyl)sebacate and the like.

These hindered amine compounds may be used alone or in combination of two or more compounds. The compound having a molecular weight of 500 or more and 5000 or less is preferable because it has preferable compatibility and thus does not bleed out on the surface of moulded articles to result in defects in appearances. The molecular weight is preferably 1000 or more and 5000 or less and particularly preferably 1500 or more and 5000 or less. When the molecular weight is less than 500, the compound may bleed out on the surface of moulded articles to result in defects in appearances and when the molecular weight is more than 5000, the composition may not satisfy the condition of melt viscosity as defined in the present invention.

Among these, a polycondensate of dimethyl succinate and 1-(2-hydroxyethyl)-4-hydroxy-2,2,6,6-tetramethylpiperidine, poly[[6-(1,1,3,3-tetramethylbutyl)imino-1,3,5-triazine-2,4-diyl][(2,2,6,6-tetramethyl-4-4-piperidyl)imino]hexamethylene[(2,2,6,6-tetramethyl-4-piperidyl)imino]], poly[(N,N′-bis(2,2,6,6-tetramethyl-4-piperidyl)hexamethylenediamine)-(4-morpholino-1,3,5-triazine-2,6-diyl)] are suitable.

### (3) Phosphorous Compound

The polyethylene resin composition for a container closure of the present invention may contain a phosphorous compound in order to prevent reduction in mechanical properties such as impact resistance and production of discoloration and odour.

The amount of the phosphorous compound may be, relative to 100 parts by weight of the polyethylene resin, 0 to 0.50 parts by weight, preferably 0.01 to 0.30 parts by weight and more preferably 0.03 to 0.10 parts by weight. The amount of the phosphorous compound of not less than 0.01 parts by weight can prevent reduction in mechanical properties such as impact resistance and production of discoloration and odour. When the amount is more than 0.50 parts by weight, the phosphorous compound may bleed out on the surface of moulded articles, resulting in defects in appearances.

The phosphorous compound as used herein is a compound containing an elemental phosphorus in a molecule, is preferably a compound used as antioxidants and may include, for example, phosphite organic compounds (organic compounds having a phosphite structure in a molecule) and phosphonite organic compounds. Specifically,
triphenyl phosphite;
tris(2,4-di-t-butylphenyl)phosphite;
tris(2,5-di-t-butylphenyl)phosphite;
tris(nonylphenyl)phosphite;
tris(dinonylphenyl)phosphite;
tris(mono- and di-mixed nonylphenyl)phosphite;
diphenyl acid phosphite;
2,2′-methylenebis(4,6-di-t-butylphenyl)octyl phosphite;
diphenyl decyl phosphite;
diphenyl octyl phosphite;
di(nonylphenyl)pentaerythritol diphosphite;
phenyl diisodecyl phosphite;
tributyl phosphite;
tris(2-ethylhexyl)phosphite;
tridecyl phosphite;
trilauryl phosphite;
dibutyl acid phosphite;
dilauryl acid phosphite;
trilauryl thiophosphite;
bis(neopentyl glycol) 1,4-cyclohexanedimethyl diphosphite;
bis(2,4-di-t-butylphenyl)pentaerythritol diphosphite;
bis(2,5-di-t-butylphenyl)pentaerythritol diphosphite;
bis(2,6-di-t-butyl-4-methylphenyl)pentaerythritol diphosphite;
bis(2,4-dicumylphenyl)pentaerythritol diphosphite;
distearyl pentaerythritol diphosphite;
tetra(C12-15-mixed alkyl)-4,4′-isopropylidene diphenylphosphite;
bis[2,2′-methylenebis(4,6-diamylphenyl)]isopropylidene diphenylphosphite;
tetra(tridecyl) 4,4′-butylidenebis(2-tert-butyl-5-methylphenol diphosphite;
hexa(tridecyl)
1,1,3-tris(2-methyl-5-tert-butyl-4-hydroxyphenyl)butane triphosphite;
2-butyl-2-ethylpropanediol 2,4,6-tri-tert-butylphenol monophosphite and the like.

Triphenyl phosphites are particularly preferred such as tris(2,4-di-t-butylphenyl)phosphite.

The polyethylene resin composition for a container closure of the present invention may contain a phenolic antioxidant at a range that does not impair the purpose of the present invention.

The amount of the phenolic antioxidant is suitably, relative to 100 parts by weight of the polyethylene resin, 0.2 parts by weight or less and preferably 0.1 parts by weight or less. The lower limit is not particularly limited and the phenolic antioxidant may not be added in consideration of discoloration. Addition of the phenolic antioxidant may improve antioxidant effect in some cases. However, addition at the amount exceeding the upper limit may not only be economically unfavourable but also produce, for example, discoloration and bleeding. The phenolic antioxidant in the polyethylene resin composition can be measured by fluorescent X-ray analysis, gas chromatography or liquid chromatography.

The phenolic antioxidant may include organic compounds having a phenol structure in a molecule which specifically include:
2,6-di-t-butyl-4-hydroxytoluene;
tris-(3,5-di-t-butyl-4-hydroxybenzyl)-isocyanurate;
1,1,3-tris(2-methyl-4-hydroxy-5-t-butylphenyl)butane;
octadecyl-3-(3,5-di-t-butyl-4-hydroxyphenyl)propionate;
pentaerythrityl-tetrakis[3-(3,5-di-t-butyl-4-hydroxyphenyl)propionate];
1,3,5-trimethyl-2,4,6-tris(3,5-di-t-butyl-4-hydroxybenzyl)benzene;
3,9-bis[2-[3-(3-t-butyl-4-hydroxy-5-methylphenyl)propionyloxy]-1,1-dimethylethyl]-2,4,8,10-tetraoxaspiro[5,5]undecane;
1,3,5-tris(4-t-butyl-3-hydroxy-2,6-dimethylbenzyl)isocyanurate 2,6-diphenyl-4-octadecyloxyphenol;
2,4-di-t-butyl-6-octylthiomethylphenol;
stearyl(3,5-di-t-butyl-4-hydroxyphenyl)propionate;
distearyl(3,5-di-t-butyl-4-hydroxybenzyl)phosphonate;
tridecyl 3,5-di-t-butyl-4-hydroxybenzylthioacetate;
thiodiethylenebis[(3,5-di-t-butyl-4-hydroxyphenyl)propionate];
4,4′-thiobis(6-t-butyl-m-cresol);
2-octylthio-4,6-di(3,5-di-t-butyl-4-hydroxyphenoxy)-s-triazine
2,2′-methylenebis(4-methyl-6-t-butylphenol);
bis[3,3-bis(4-hydroxy-3-t-butylphenyl)butyric acid]glycol ester;
4,4′-butylidenebis(2,6-di-t-butylphenol);
4,4′-butylidenebis(6-t-butyl-3-methylphenol);
2,2′-ethylidenebis(4,6-di-t-butylphenol);
1,1,3-tris(2-methyl-4-hydroxy-5-t-butylphenyl)butane;
bis[2-t-butyl-4-methyl-6-(2-hydroxy-3-t-butyl-5-methylbenzyl)phenyl]terephthalate;
1,3,5-tris(2,6-dimethyl-3-hydroxy-4-t-butylbenzyl)isocyanurate 1,3,5-tris(3,5-di-t-butyl-4-hydroxybenzyl)isocyanurate;
1,3,5-tris(3,5-di-t-butyl-4-hydroxybenzyl)-2,4,6-trimethylbenz ene;
1,3,5-tris[(3,5-di-t-butyl-4-hydroxyphenyl)propionyloxyethyl]isocyanurate;
tetrakis[methylene-3-(3′,5′-di-t-butyl-4′-hydroxyphenyl)propionate]methane;
2-t-butyl-4-methyl-6-(2-acryloyloxy-3-t-butyl-5-methylbenzyl)phenol;
3,9-bis[2-(3-t-butyl-4-hydroxy-5-methylhydrocinnamoyloxy)-1,1-dimethylethyl]-2,4,8,10-tetraoxaspiro[5.5]undecane;
triethylene glycol bis[β-(3-t-butyl-4-hydroxy-5-methylphenyl)propionate];
tetrakis(2,4-di-t-butylphenyl) [1,1-biphenyl]-4,4′-diyl bisphosphonite and the like.

Particularly preferable phenolic antioxidant may include tetrakis-[methylene(3,5-di-t-butyl-4-hydroxyhydro-cinnamate)]methane (IRGANOX 1010) and n-octadecyl-3-(3′,5′-di-t-butyl-4′-hydroxyphenyl)propionate (IRGANOX 1076).

The polyethylene resin composition for a container closure of the present invention may further contain a sulphur-containing antioxidant at a range that does not impair the purpose of the present invention.

The amount of the sulphur-containing antioxidant which can be added is, relative to 100 parts by weight of the polyethylene resin, 0.2 parts by weight or less and preferably 0.1 parts by weight or less. The lower limit is not particularly limited and the sulphur-containing antioxidant may not be added in consideration of colouring. Absence of addition of the sulphur-containing antioxidant may result in insufficient antioxidant effect in some cases, while addition at the amount exceeding the upper limit may not only be economically unfavourable but also produce discoloration and bleeding. The sulphur-containing antioxidant in the polyethylene resin composition can be measured by fluorescent X-ray analysis, gas chromatography or liquid chromatography.

The sulphur-containing antioxidant may include compounds containing a sulphur element in a molecule which specifically include:
di-lauryl-3,3′-thio-di-propionate;
di-myristyl-3,3′-thio-di-propionate;
di-stearyl-3,3′-thio-di-propionate;
pentaerythrityl-tetrakis(3-lauryl-thiopropionate) and the like.

The polyethylene resin of the present invention may contain, if necessary, appropriate amounts of various well known additives and fillers such as talc and mica. The additive may include, for example, antioxidants other than those mentioned above, lubricants, antistatic agents, light stabilizers, ultraviolet absorbing agents, colorants, pigments and dyes.

One or two or more additives may be used in combination. However, in principle, it is preferable that additives other than the above hindered amine compound and antioxidants are not added as far as the requirements defined in the present invention are fulfilled.

### (5) Properties of Polyethylene Resin Composition for Container Closures

The polyethylene resin composition for a container closure of the present invention contains, relative to 100 parts by weight of the polyethylene resin, 0.01 to 0.50 parts by weight of the hindered amine compound and has the following properties (a) to (f).

(a) MFR and HLMFR

The polyethylene resin composition for a container closure of the present invention has a melt flow rate measured at temperature of 190° C. under a load of 2.16 kg (MFR) of 0.5 to 10 g/10 min, preferably 0.7 to 6 g/10 min and still more preferably 0.8 to 3.5 g/10 min.

The composition further has a melt flow rate measured at a temperature of 190° C. under a load of 21.6 kg (HLMFR) of 100 to 500 g/10 min, preferably 110 to 450 g/10 min and still more preferably 120 to 320 g/10 min and has HLMFR/MFR of 50 to 200, preferably 55 to 150 and still more preferably 60 to 110.

When HLMFR is less than 100 g/10 min, the mouldability at high speed is impaired even when MFR is in the range of 0.5 to 10 g/10 min. When MFR is more than 10 g/10 min, the stress cracking resistance is impaired, resulting in undesirable embodiment even when HLMFR is 100 to 500 g/10 min. Meanwhile it is difficult to achieve HLMFR of 100 to 500 g/10 min when MFR is less than 0.5 g/10 min, naturally resulting in impaired mouldability at high speed. When HLMFR/MFR is less than 50, the stress cracking resistance is impaired and simultaneously elongation is increased, causing difficulty in breakage of bridge portions of container closures and making the composition less suitable for container closures. When HLMFR/MFR is higher than 200, the die swell is extremely increased, resulting in impaired mouldability.

(b) Density

The polyethylene resin composition of the present invention has a density of 0.956 to 0.980 g/cm³. Having the density of 0.956 g/cm³ or more provides excellent sliding property and high level of rigidity and prevents container closures from deforming even at high temperatures. Compositions having a density of less than 0.956 g/cm³ are not preferable because they have impaired sliding property and rigidity and cause easy deformation of container closures. The upper limit of the density is generally around 0.980 g/cm³.

(c) Flexural Modulus of Injection Moulding Test Specimen

The polyethylene resin composition of the present invention has a flexural modulus of an injection moulding test specimen of 990 to 2000 MPa. The flexural modulus is more preferably 1050 MPa or more and 2000 MPa or less, and still more preferably 1100 MPa or more and 2000 MPa or less. The composition having a flexural modulus of less than 990 MPa has impaired rigidity and cause easy deformation of container closures particularly at high temperatures. The upper limit of the flexural modulus is generally around 2000 MPa for polyethylenes.

As used herein, the flexural modulus is determined according to JIS-K6922-2: 1997 with a test specimen of 4×10×80 mm prepared by injection moulding at 210° C.

(d) Constant Strain ESCR of Injection Moulding Test Specimen

The polyethylene resin composition of the present invention has a constant strain ESCR of an injection moulding test specimen of 10 to 400 hours, preferably, in view of balances between physical properties and required performances for container closures, 20 to 40 hours and more preferably 30 to 400 hours. This property is the stress cracking resistance under constant strain and specifically follows JIS-K6922-2: 1997. The test specimen is obtained by cutting out from a plate having a dimension of 120×120×2 mm prepared by injection moulding at 190° C.

When the constant strain ESCR is less than 10 hours, container closures may be easily broken due to stress, causing leakage of liquid contents. When the constant strain ESCR is more than 400 hours, although it may provide preferable stress cracking resistance, it is difficult to achieve both high rigidity and flowability suitable for moulding container closures.

(e) Tensile Elongation at Break

The polyethylene resin composition of the present invention has a tensile elongation at break of 190% or less. The tensile elongation at break is determined according to JIS-K7113: 1995 (type 2 test specimen). When the tensile elongation at break is more than 190%, breaking bridge portions of a container closure may be difficult, making the composition less suitable for container closures. The tensile elongation at break is preferably 100% or less and more preferably 80% or less. The lower limit of the tensile elongation at break is not particularly limited and is preferably 5% or more, taking into account the suitability as container closures.

(f) Melt Viscosity

The polyethylene resin composition of the present invention is required to have a melt viscosity as measured on a capillary rheometer at 200° C. and a shear rate of 200 sec⁻¹ of 470 Pa·s or less. The melt viscosity is more preferably 400 Pa·s or less and still more preferably 350 Pa·s or less. Due to this property, high flowability can be obtained and thus moulding at high speed is feasible, allowing high-cycle moulding. The lower limit of the melt viscosity is not particularly limited and is generally preferably 50 Pa·s or more in view of mouldability, balances between physical properties and balances between required performances for caps.

The melt viscosity is determined according to JIS-K-7199: 1999 and specifically determined on an Intesco fully automated capillary rheometer from Intesco Co., Ltd. at 200° C. with a capillary having d=1 mm and L/D=30.

The polyethylene resin composition for a container closure of the present invention has the above properties (a) to (f) and preferably has the following properties (g) to (i).

(g) Hydrocarbon Volatile Matter Content

The polyethylene resin composition of the present invention preferably has a hydrocarbon volatile matter content of 100 ppm or less. The term “hydrocarbon” as used herein refers to compounds containing at least carbon and hydrogen and determined generally by gas chromatography. By fulfilling this requirement, transfer of odour-causing materials from the container closure to the content of the container can be prevented.

Specifically, the volatile matter content is determined by measuring by gas chromatography headspace air in a 25-ml glass airtight container containing 1 g of a polyethylene resin composition which is heated at 130° C. for 60 minutes. The hydrocarbon volatile matter content is 100 ppm or less, preferably 70 ppm or less and still more preferably 50 ppm or less expressed in terms of the amount of n-hexane. When the hydrocarbon volatile matter content is higher than 100 ppm, odour may be generated. The lower limit of the hydrocarbon volatile matter content is preferably as close to zero as possible and thus is not particularly limited. In order to adjust the hydrocarbon volatile matter content at or lower than the predetermined value in the present invention, the polymerized polyethylene resin may be subjected to the treatment for volatile matter content removal such as steam stripping, vacuum treatment, nitrogen purge and hot air deodorizing.

(h) Coefficient of Static Friction

The polyethylene resin composition of the present invention preferably has a coefficient of static friction of 0.40 or less, more preferably 0.30 or less and still more preferably 0.25 or less. The coefficient of static friction as used herein is determined according to JIS-K-7125: 1999. Alternatively it may also be determined by measuring both sides of a flat plate of 120×120×2 mm moulded at 190° C. on an injection moulding machine IS-150 from Toshiba Machine Co. Ltd. with TriboGear Muse 94i from Shinto Scientific Co., Ltd. The composition having this scale of more than 0.40 may have impaired sliding property and may cause troubles for opening and closing of container closures. The lower limit of the coefficient of static friction is not particularly limited and is generally 0.1 or more.

(i) Variation (ΔYI) in Chromaticity (YI Value) after Irradiation with Electron Beams

The polyethylene resin composition of the present invention preferably has a variation (ΔYI) in chromaticity (YI value) of 2 or less when a sheet-shaped test specimen having a thickness of 2 mm is irradiated with electron beams at an absorbed dose of 30 kGy. The YI value is determined according to JIS-K7105: 1981. The composition having ΔYI of higher than 2 may generate odour, have decreased mouldability and cause deteriorated appearance of container closures. The ΔYI is preferably −2 or more in view of appearance of container closures and may generally be 0 or more. Thus the ΔYI is preferably −2 to 1.9.

The odour can be measured by a sensory test of a sheet-shaped test specimen having a thickness of 2 mm irradiated with electron beams at an absorbed dose of 30 kGy for 3 hours. Apparently the result without odour is preferable.

The variation (ΔYI) described above can be significantly improved by adjusting the amount of the hindered amine compound added.

The polyethylene resin composition of the present invention fulfils the above requirements (a) to (f) and preferably fulfils the requirements (g) to (i) as well. The composition may consist of only one polyethylene polymer or may comprise two or more polyethylene polymers having different physical properties as far as the composition fulfils the above requirements.

The preferable composition comprises the polyethylene polymer component (A) as described below at 10% by weight or more and 45% by weight or less and the polyethylene polymer component (B) at 55% by weight or more and 90% by weight or less, and more preferably the composition comprises the polyethylene polymer component (A) at 20% by weight or more and 35% by weight or less and the polyethylene polymer component (B) at 65% by weight or more and 80% by weight or less. The composition may be obtained by, as far as the composition comprises the components within these ranges, separately polymerizing the components and blending the components thereafter or more preferably by continuously polymerizing the components. It is noted that (A)+(B)=100% by weight.

By including the component (A) at 10% by weight or more, the stress cracking resistance is improved and by including the component (A) at 45% by weight or less, the mouldability is improved. When the component (A) is less than 10% by weight, the stress cracking resistance may be deteriorated and when the component (A) is more than 45% by weight, the mouldability may be deteriorated.

The ethylene polymer component (A) has a HLMFR of 0.1 to 10 g/10 min and a density of 0.926 to 0.955 g/cm³ and the ethylene polymer component (B) has a MFR of 25 g/10 min or more and a density of 0.961 to 0.980 g/cm³.

The ethylene polymer component (A) preferably has a HLMFR of 1 to 10 g/10 min. When the value is less than 0.1 g/10 min, the flowability may be deteriorated and the mouldability may be impaired and when the value is more than 10 g/10 min, the stress cracking resistance may be deteriorated.

The ethylene polymer component (A) having a density of less than 0.926 g/cm³ may have insufficient rigidity. The ethylene polymer component (A) having a density of more than 0.955 g/cm³ may have decreased durability.

The ethylene polymer component (B) having a MFR of less than 25 g/10 min may have deteriorated flowability and the one having a density of less than 0.961 g/cm³ may have decreased rigidity. The upper limit of MFR of the ethylene polymer component (B) is not particularly limited and is generally 500 g/10 min. The upper limit of MFR of the component (B) is not particularly limited as far as the composition of the mixture of the components (A) and (B) has a MFR of 0.5 to 10 g/10 min, a HLMFR Of 100 to 500 g/10 min and HLMFR/MFR of 50 to 200. The upper limit of the density of the component (B) is not particularly limited and is generally around 0.980 g/cm³.

The polyethylene resin of the present invention may be obtained by directly polymerizing the resin having the above properties or may be obtained by polymerizing continuously or separately the ethylene polymer components (A) and (B) and blending the components. Because of the ease of polymerization procedures and ease of securing the homogeneity of the composition, the suitable resin is preferably obtained by continuous polymerization in multiple polymerization reactors connected in series such as two polymerization reactors. In any case the polymerization catalyst may include Ziegler catalysts, Phillips catalysts, single site catalysts such as metallocene catalysts and other various catalysts. Polymerization may be carried out in an organic solvent, in liquid monomers or in a gas phase. In a so-called multi-stage polymerization wherein polymerization is continuously carried out in multiple polymerization reactors connected in series, the ethylene polymer (corresponding to component (A)) which is a high-molecular weight component is produced in the first reactor by polymerizing ethylene or co-polymerizing ethylene with an α-olefin, followed by introduction of ethylene and hydrogen into the same polymerization system to produce the ethylene polymer (corresponding to component (B)) which is a low-molecular weight component in the second reactor, resulting in preparation of the polyethylene resin containing the high-molecular weight component and the low-molecular weight component.

In the multi-stage polymerization, an ethylene polymer produced in the polymerization range at or after the second reactor can be determined for the amount thereof by measuring the yield of the polymer at each reactor (can be determined by an analysis of unreacted gas and the like) and for the physical properties thereof by measuring the physical properties of the polymers taken out after respective reactors and converting the values according to additive properties.

The polyethylene resin composition of the present invention may include, as it is produced by using the polyethylene polymerization catalyst, a residue deactivating agent of polyethylene polymerization catalysts such as metal soap e.g., calcium stearate. The properties of the polyethylene resin composition of the present invention are not affected by the residue deactivating agent.

2. Container Closure

The polyethylene resin composition according to the present invention is suitable as a material for container closures for containers such as PET bottles particularly for beverages which are sold warm. The container closure of the resin composition of the present invention may be obtained by any moulding method without limitation and preferably by injection moulding or compression moulding.

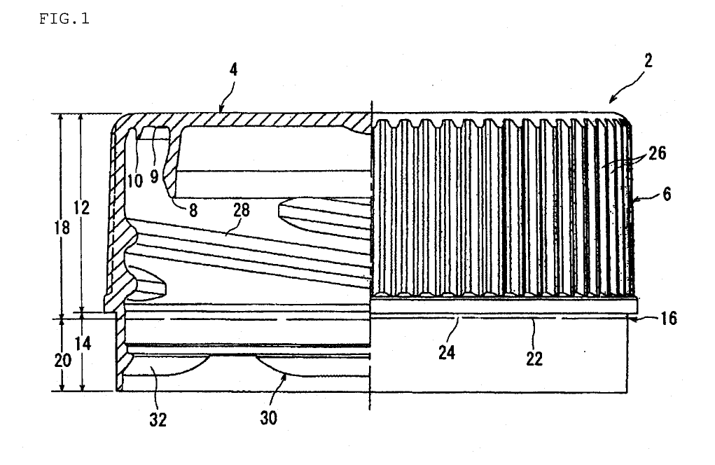

The container closure of the present invention may have the shape and configuration as shown in FIG. 1, for example. The container closure 2 includes a circular top panel 4 and a cylindrical skirt wall 6 vertically suspending from a periphery of the top panel wall 4, wherein an outer circumferential edge of the inner surface of the top panel wall 4 contains a cylindrical inner sealing piece 8 vertically suspending downward and a cylindrical outer sealing piece 10 again vertically suspending downward. A relatively small ring-shaped elongated protrusion 9 is further formed between the inner sealing piece 8 and the outer sealing piece 10.

The skirt wall 6 contains an upper thick-walled portion 12 with a relatively high thickness and a lower thin-walled portion 14 with a relatively low thickness. The lower thin-walled portion 14 includes a breakage line 16 extending along a circumferential direction formed at the upper edge of the lower thin-walled portion 14 and the skirt wall 6 is divided into a main portion 18 which is above the breakage line 16 and a tamper-evident bottom portion 20 which is below the breakage line 16. The breakage line 16 includes a plurality of slits (cut grooves) 22 extending along the circumferential direction with intervals and a plurality of bridges 24 rendered to be remained between slits 22, and the tamper-evident bottom portion 20 is linked to the main portion 18 through a plurality of bridges 24.

The main portion 18 of the skirt wall has, on an outer circumferential surface thereof, anti-slip knurls 26 which are projections and depressions alternately formed along the circumferential direction. The main portion 18 of the skirt wall 6 has, on an inner circumferential surface thereof, a 3-line elongated female screw 28. The 3-line elongated female screw 28 is provided at intervals with an angle of 120 degrees and each line of the 3-line elongated female screw 28 is elongated over the angle range of about 160 degrees. The tamper-evident bottom portion 20 contains an engaging means 30 provided on an inner circumferential surface thereof. According to the embodiment of the present invention, the engaging means 30 is formed with 5 projections 32 which are provided at intervals along the circumferential direction and extend along the circumferential direction. The respective main portion (a portion excluding both edges) of the projections 32 has a longitudinal section profile of an approximately right triangle and has an upper plane which extends slightly downward along the radial direction inwardly.

The container closure of the present invention contains the resin composition as described above and thus has satisfactory properties such that the closure has high rigidity, can be opened easily and has a low hydrocarbon volatile matter content that may provide odour to the content.

### EXAMPLES

The present invention is further specifically described by way of Examples hereinbelow, which do not limit the present invention.

Physical properties of polyethylene resins and polyethylene resin compositions of the following Examples and Comparative Examples are determined as follows.

MFR: MFR was determined according to JIS-K6922-2: 1997. The melt flow rate (MFR) was measured at a temperature of 190° C. under a load of 2.16 kg and the melt flow rate (HLMFR) was measured at a temperature of 190° C. under a load of 21.6 kg.

Density: The density was measured according to JIS-K6922-1, 2: 1997.

Flexural modulus: The flexural modulus was measured according to JIS-K6922-2: 1997 by preparing a test specimen of 4×10×80 mm by injection moulding at 210° C.

Constant strain ESCR: The constant strain ESCR was measured according to JIS-K6922-2: 1997 by preparing a test specimen of 4×10×80 mm by injection moulding at 210° C.

Tensile elongation at break: The tensile elongation at break was measured according to JIS-K7113: 1995 (type 2 test specimen).

Melt viscosity: The melt viscosity was measured according to JIS-K-7199: 1999, and specifically determined on an Intesco fully automated capillary rheometer from Intesco Co., Ltd. at 200° C. with a capillary having d=1 mm and L/D=30 at a shear rate of 200 sec⁻¹.

Hydrocarbon volatile matter content: The hydrocarbon volatile matter content was determined by measuring by gas chromatography for volatile matter content of headspace air in a 25-ml glass airtight container containing 1 g of a polyethylene resin composition which was heated at 130° C. for 60 minutes and converting the result to the amount of n-hexane.

Coefficient of static friction: The coefficient of static friction was determined according to JIS-K-7125: 1999.

Variation (ΔYI) in chromaticity (YI value) after irradiation with electron beams: This property was determined by irradiating a sheet-shaped test specimen having a thickness of 2 mm with electron beams at an absorbed dose of 30 kGy and measuring the variation (ΔYI) in chromaticity (YI value) after the irradiation.

Odour after irradiation with electron beams: This property was determined by a sensory test for odour of a sheet-shaped test specimen having a thickness of 2 mm after irradiation with electron beams at an absorbed dose of 30 kGy for 3 hours. The specimen without odour was evaluated as “o” and the specimen with strong odour was evaluated as “x”.

Mouldability: The mouldability was evaluated by subjecting a material to compression moulding at a high speed and determining whether or not a container closure was properly moulded. The container closure integrally moulded had the same shape as commercial container closures (outer diameter: about 3 cm, height: about 2 cm) which had bridges for conferring the tamper-evident property. The material that allowed preferable moulding without troubles was evaluated as “o” and the material that had a decreased flowability and thus increased the motor load of the extruder resulting in difficulty in extrusion or that did not allow moulding of a predetermined shape (container closure) was evaluated as “x”.

Container closure shape retention capacity: The container closure shape retention capacity was determined as follows: moulded container closures were stacked in a constant temperature room at room temperature of 23° C. and humidity of 50% for 40 hours and the container closures which did not show deformation were evaluated as “o” and the container closures which apparently showed deformation were evaluated as “x”.

Breakage property of container closure bridges: A 500-ml PET bottle was filled with water and sealed with a container closure prepared (having a bridge structure). The cap screwed was then manually opened under heating at 65° C. and the breakage of the bridge after opening was observed. The breakage property of container closure bridges was evaluated according to the breakage under this condition.

### Example 1

A Ziegler catalyst, a monomer, i.e., ethylene, and a comonomer, i.e., 1-butene, were subjected to slurry polymerization in a continuous two-reactor polymerization apparatus to polymerize the component (A) followed by polymerization of the component (B) indicated in Table 1, resulting in production of polyethylene. The amount ratio, MFR and HLMFR of the resin as well as measured values are shown in Table 1. Thus monomers, i.e., ethylene and 1-butene, were fed in the first reactor polymerization and ethylene was fed in the second reactor polymerization to produce polyethylene which was then subjected to steam stripping. The amount (amount ratio) and physical properties of the component (B) produced in the second reactor were determined from the yield at each reactor obtained based on an analysis of unreacted gas at each reactor and from physical properties of resin components after the first and second reactors followed by conversion according to additive properties.

To 100 parts by weight of the thus obtained polyethylene resin were added 0.05 parts by weight of poly[{6-(1,1,3,3-tetramethylbutyl)amino-1,3,5-triazine-2,4-diyl)}{(2,2,6,6-tetramethyl-4-piperidyl)imino}hexamethylene{(2,2,6,6-tetramethyl-4-piperidyl)imino}]polycondensate (BASF, Chimassorb 944, CAS No. 71878-19-8, molecular weight: 2000 to 3100) and 0.05 parts by weight of tris(2,4-di-t-butylphenyl)phosphite (BASF, Irgafos 168, CAS No. 31570-04-4) to obtain a polyethylene resin composition.

The polyethylene resin composition of Example 1 had preferable flexural modulus, stress cracking resistance (constant strain ESCR), mouldability (melt viscosity), volatile matter content and breakage property of container closure bridges and also had preferable electron beam resistance.

### Example 2

A polyethylene resin composition was obtained in the similar manner as Example 1 except that the amount of the hindered amine compound was increased as shown in Table 1. As shown in Table 1, the obtained polyethylene resin composition had preferable flexural modulus, stress cracking resistance (constant strain ESCR), mouldability (melt viscosity), volatile matter content and breakage property of container closure bridges and also had preferable electron beam resistance. Specifically the variation (ΔYI) in chromaticity (YI value) before and after irradiation with electron beams was improved compared to Example 1.

### Example 3

A polyethylene resin composition was obtained in the similar manner as Example 1 except that the amount of the hindered amine compound was increased and the phosphorous compound was not used as shown in Table 1. As shown in Table 1, the obtained polyethylene resin composition had preferable flexural modulus, stress cracking resistance (constant strain ESCR), mouldability (melt viscosity), volatile matter content and breakage property of container closure bridges and also had preferable electron beam resistance.

### Example 4

A polyethylene resin composition was obtained in the similar manner as Example 3 except that the amount of the hindered amine compound was increased as shown in Table 1. As shown in Table 1, the obtained polyethylene resin composition had preferable flexural modulus, stress cracking resistance (constant strain ESCR), mouldability (melt viscosity), volatile matter content and breakage property of container closure bridges and also had preferable electron beam resistance. Specifically the variation (ΔYI) in chromaticity (YI value) before and after irradiation with electron beams was improved compared to Example 3.

### Example 5

A polyethylene resin composition was obtained in the similar manner as Example 1 except that the types and proportions of the components (A) and (B) were changed and the phosphorous compound was not used as shown in Table 1. As shown in Table 1, the obtained polyethylene resin composition had preferable flexural modulus, stress cracking resistance (constant strain ESCR), mouldability (melt viscosity), volatile matter content and breakage property of container closure bridges and also had preferable electron beam resistance.

### Example 6

A polyethylene resin composition was obtained in the similar manner as Example 5 except that the amount of the hindered amine compound was changed as shown in Table 1. As shown in Table 1, the obtained polyethylene resin composition had preferable flexural modulus, stress cracking resistance (constant strain ESCR), mouldability (melt viscosity), volatile matter content and breakage property of container closure bridges and also had preferable electron beam resistance.

### Example 7

A polyethylene resin composition was obtained in the similar manner as Example 5 except that the amount of the hindered amine compound was changed as shown in Table 1. As shown in Table 1, the obtained polyethylene resin composition had preferable flexural modulus, stress cracking resistance (constant strain ESCR), mouldability (melt viscosity), volatile matter content and breakage property of container closure bridges and also had preferable electron beam resistance.

### Example 8

A polyethylene resin composition was obtained in the similar manner as Example 5 except that the amount of the hindered amine compound was changed as shown in Table 1. As shown in Table 1, the obtained polyethylene resin composition had preferable flexural modulus, stress cracking resistance (constant strain ESCR), mouldability (melt viscosity), volatile matter content and breakage property of container closure bridges and also had preferable electron beam resistance. Specifically the variation (ΔYI) in chromaticity (YI value) before and after irradiation with electron beams was significantly improved compared to Example 5.

### Example 9

A polyethylene resin composition was obtained in the similar manner as Example 1 except that the types and proportions of the components (A) and (B) were changed and the hindered amine compound used was dimethyl succinate-1-(2-hydroxyethyl)-4-hydroxy-2,2,6,6-tetramethylpiperidine polycondensate (BASF, Tinuvin 622, CAS No. 65447-77-0, molecular weight: 3100 to 4000) as shown in Table 1. As shown in Table 1, the obtained polyethylene resin composition had preferable flexural modulus, stress cracking resistance (constant strain ESCR), mouldability (melt viscosity), volatile matter content and breakage property of container closure bridges and also had preferable electron beam resistance.

### Example 10

A polyethylene resin composition was obtained in the similar manner as Example 9 except that the amount of the hindered amine compound was changed and the phosphorus compound was not used as shown in Table 1. As shown in Table 1, the obtained polyethylene resin composition had preferable flexural modulus, stress cracking resistance (constant strain ESCR), mouldability (melt viscosity), volatile matter content and breakage property of container closure bridges and also had preferable electron beam resistance.

### Example 11

A polyethylene resin composition was obtained in the similar manner as Example 9 except that the amount of the hindered amine compound was changed and the phosphorus compound was not used as shown in Table 1. As shown in Table 1, the obtained polyethylene resin composition had preferable flexural modulus, stress cracking resistance (constant strain ESCR), mouldability (melt viscosity), volatile matter content and breakage property of container closure bridges and also had preferable electron beam resistance.

### Example 12

A polyethylene resin composition was obtained in the similar manner as Example 11 except that the types and proportions of the components (A) and (B) were changed as shown in Table 1. As shown in Table 1, the obtained polyethylene resin composition had preferable flexural modulus, stress cracking resistance (constant strain ESCR), mouldability (melt viscosity), volatile matter content and breakage property of container closure bridges and also had preferable electron beam resistance.

### Example 13

A polyethylene resin composition was obtained in the similar manner as Example 12 except that the type of the component (B) was changed as shown in Table 1. As shown in Table 1, the obtained polyethylene resin composition had preferable flexural modulus, stress cracking resistance (constant strain ESCR), mouldability (melt viscosity), volatile matter content and breakage property of container closure bridges and also had preferable electron beam resistance.

### Example 14

A polyethylene resin composition was obtained in the similar manner as Example 6 except that the types and proportions of the components (A) and (B) were changed as shown in Table 1. As shown in Table 1, the obtained polyethylene resin composition had preferable flexural modulus, stress cracking resistance (constant strain ESCR), mouldability (melt viscosity), volatile matter content and breakage property of container closure bridges and also had preferable electron beam resistance.

TABLE 1

| | | | | Example | | | | | | |
|---|---|---|---|---|---|---|---|---|---|---|
| | | | Unit | 1 | 2 | 3 | 4 | 5 | 6 | 7 |
| Polyeth- | Compo- | HLMFR | g/10 | 2 | 2 | 2 | 2 | 5 | 5 | 5 |
| ylene | nent (A) | | min | | | | | | | |
| resin | | Density | g/cm3 | 0.942 | 0.942 | 0.942 | 0.942 | 0.937 | 0.937 | 0.937 |
| | | Comonomer | — | 1-butene | 1-butene | 1-butene | 1-butene | 1-butene | 1-butene | 1-butene |
| | | Weight ratio in | wt % | 21 | 21 | 21 | 21 | 22 | 22 | 22 |
| | | polyethylene | | | | | | | | |
| | | resin | | | | | | | | |
| | Compo- | MFR | g/10 | 200 | 200 | 200 | 200 | 60 | 60 | 60 |
| | nent (B) | | min | | | | | | | |
| | | Density | g/cm3 | 0.970 | 0.970 | 0.970 | 0.970 | 0.970 | 0.970 | 0.970 |
| | | Weight ratio in | wt % | 79 | 79 | 79 | 79 | 78 | 78 | 78 |
| | | polyethylene | | | | | | | | |
| | | resin | | | | | | | | |

| Hindered amine | Type | — | Chimassorb | Chimassorb | Chimassorb | Chimassorb | Chimassorb | Chimassorb | Chimassorb |
|---|---|---|---|---|---|---|---|---|---|
| compound | | | 944 | 944 | 944 | 944 | 944 | 944 | 944 |
| | Amount | parts | 0.05 | 0.1 | 0.15 | 0.3 | 0.05 | 0.1 | 0.15 |
| | relative to 100 | by | | | | | | | |
| | wt parts of | weight | | | | | | | |
| | polyethylene | | | | | | | | |
| | resin | | | | | | | | |
| Phosphorous | Type | — | Irgafos | Irgafos | — | — | — | — | — |
| compound | | | 168 | 168 | | | | | |
| | Amount | parts | 0.05 | 0.05 | 0 | 0 | 0 | 0 | 0 |
| | relative to 100 | by | | | | | | | |
| | wt parts of | weight | | | | | | | |
| | polyethylene | | | | | | | | |
| | resin | | | | | | | | |
| Polyethylene resin | MFR | g/10 | 3.5 | 3.5 | 3.5 | 3.5 | 3.5 | 3.5 | 3.5 |
| composition and | | min | | | | | | | |
| container closure | HLMFR | g/10 | 300 | 300 | 300 | 300 | 220 | 220 | 220 |
| prepared from | | min | | | | | | | |
| the resin | HLMFR/MFR | — | 86 | 86 | 86 | 86 | 63 | 63 | 63 |
| composition | Density | g/cm3 | 0.963 | 0.963 | 0.963 | 0.963 | 0.960 | 0.960 | 0.960 |
| | Flexural | MPa | 1100 | 1100 | 1100 | 1100 | 1000 | 1000 | 1000 |
| | modulus | | | | | | | | |
| | Constant | hour | 15 | 15 | 15 | 15 | 15 | 15 | 15 |
| | strain ESCR | | | | | | | | |
| | Tensile | % | 60 | 60 | 60 | 60 | 58 | 58 | 58 |
| | elongation at | | | | | | | | |
| | break | | | | | | | | |
| | Melt viscosity | Pa · s | 320 | 320 | 320 | 320 | 350 | 350 | 350 |
| | Hydrocarbon | ppm | 35 | 35 | 35 | 35 | 40 | 40 | 40 |
| | volatile | | | | | | | | |
| | matter content | | | | | | | | |
| | Coefficient of | — | 0.19 | 0.19 | 0.19 | 0.19 | 0.21 | 0.21 | 0.21 |
| | static | | | | | | | | |
| | friction | | | | | | | | |
| | Variation in | — | 1.9 | 1.8 | 1.8 | 1.7 | 1.9 | 1.8 | 1.8 |
| | chromaticity | | | | | | | | |
| | (YI value) | | | | | | | | |
| | after | | | | | | | | |
| | irradiation | | | | | | | | |
| | with electron | | | | | | | | |
| | beams | | | | | | | | |
| | Odour after | — | ∘ | ∘ | ∘ | ∘ | ∘ | ∘ | ∘ |
| | irradiation | | | | | | | | |
| | with electron | | | | | | | | |
| | beams | | | | | | | | |
| | Mouldability | — | ∘ | ∘ | ∘ | ∘ | ∘ | ∘ | ∘ |
| | Breakage | — | Good | Good | Good | Good | Good | Good | Good |
| | property of | | | | | | | | |
| | container | | | | | | | | |
| | closure | | | | | | | | |
| | bridges | | | | | | | | |
| | Container | — | ∘ | ∘ | ∘ | ∘ | ∘ | ∘ | ∘ |
| | closure shape | | | | | | | | |
| | retention | | | | | | | | |
| | capacity | | | | | | | | |
| | Overall | — | ∘ | ∘ | ∘ | ∘ | ∘ | ∘ | ∘ |
| | evaluation | | | | | | | | |

| | | | | Example | | | | | | |
|---|---|---|---|---|---|---|---|---|---|---|
| | | | Unit | 8 | 9 | 10 | 11 | 12 | 13 | 14 |
| Polyeth- | Compo- | HLMFR | g/10 | 5 | 6 | 6 | 6 | 0.5 | 0.5 | 0.2 |
| ylene | nent (A) | | min | | | | | | | |
| resin | | Density | g/cm3 | 0.937 | 0.938 | 0.938 | 0.938 | 0.942 | 0.942 | 0.927 |
| | | Comonomer | — | 1-butene | 1-butene | 1-butene | 1-butene | 1-butene | 1-butene | 1-butene |
| | | Weight ratio in | wt % | 22 | 26 | 26 | 26 | 21 | 21 | 25 |
| | | polyethylene | | | | | | | | |
| | | resin | | | | | | | | |
| | Compo- | MFR | g/10 | 60 | 280 | 280 | 280 | 35 | 100 | 180 |
| | nent (B) | | min | | | | | | | |
| | | Density | g/cm3 | 0.970 | 0.972 | 0.972 | 0.972 | 0.967 | 0.967 | 0.969 |
| | | Weight ratio in | wt % | 78 | 74 | 74 | 74 | 79 | 79 | 75 |
| | | polyethylene | | | | | | | | |
| | | resin | | | | | | | | |

| Hindered amine | Type | — | Chimassorb | Tinuvin | Tinuvin | Tinuvin | Tinuvin | Tinuvin | Chimassorb |
|---|---|---|---|---|---|---|---|---|---|
| compound | | | 944 | 622 | 622 | 622 | 622 | 622 | 944 |
| | Amount | parts | 0.4 | 0.05 | 0.1 | 0.15 | 0.15 | 0.15 | 0.1 |
| | relative to 100 | by | | | | | | | |
| | wt parts of | weight | | | | | | | |
| | polyethylene | | | | | | | | |
| | resin | | | | | | | | |
| Phosphorous | Type | — | — | Irgafos | — | — | — | — | — |
| compound | | | | 168 | | | | | |
| | Amount | parts | 0 | 0.05 | 0 | 0 | 0 | 0 | 0 |
| | relative to 100 | by | | | | | | | |
| | wt parts of | weight | | | | | | | |
| | polyethylene | | | | | | | | |
| | resin | | | | | | | | |
| Polyethylene resin | MFR | g/10 | 3.5 | 5.0 | 5.0 | 5.0 | 1.3 | 2.3 | 0.7 |
| composition and | | min | | | | | | | |
| container closure | HLMFR | g/10 | 220 | 400 | 400 | 400 | 104 | 220 | 110 |
| prepared from | | min | | | | | | | |
| the resin | HLMFR/MFR | — | 63 | 80 | 80 | 80 | 80 | 96 | 157 |
| composition | Density | g/cm3 | 0.960 | 0.960 | 0.960 | 0.960 | 0.962 | 0.962 | 0.958 |

| | | | | | | | | |
|---|---|---|---|---|---|---|---|---|
| Flexural | MPa | 1000 | 1000 | 1000 | 1000 | 1050 | 1050 | 990 |
| modulus | | | | | | | | |
| Constant | hour | 15 | 20 | 20 | 20 | 20 | 15 | 200 |
| strain ESCR | | | | | | | | |
| Tensile | % | 58 | 42 | 42 | 42 | 80 | 70 | 40 |
| elongation at | | | | | | | | |
| break | | | | | | | | |
| Melt viscosity | Pa · s | 350 | 280 | 280 | 280 | 400 | 360 | 390 |
| Hydrocarbon | ppm | 40 | 32 | 32 | 32 | 35 | 40 | 40 |
| volatile | | | | | | | | |
| matter content | | | | | | | | |
| Coefficient of | — | 0.21 | 0.22 | 0.22 | 0.22 | 0.20 | 0.20 | 0.40 |
| static | | | | | | | | |
| friction | | | | | | | | |
| Variation in | — | 1.7 | 1.8 | 1.8 | 1.9 | 1.9 | 1.9 | 1.9 |
| chromaticity | | | | | | | | |
| (YI value) | | | | | | | | |
| after | | | | | | | | |
| irradiation | | | | | | | | |
| with electron | | | | | | | | |
| beams | | | | | | | | |
| Odour after | — | ∘ | ∘ | ∘ | ∘ | ∘ | ∘ | ∘ |
| irradiation | | | | | | | | |
| with electron | | | | | | | | |
| beams | | | | | | | | |
| Mouldability | — | ∘ | ∘ | ∘ | ∘ | ∘ | ∘ | ∘ |
| Breakage | — | Good | Good | Good | Good | Good | Good | Good |
| property of | | | | | | | | |
| container | | | | | | | | |
| closure | | | | | | | | |
| bridges | | | | | | | | |
| Container | — | ∘ | ∘ | ∘ | ∘ | ∘ | ∘ | ∘ |
| closure shape | | | | | | | | |
| retention | | | | | | | | |
| capacity | | | | | | | | |
| Overall | — | ∘ | ∘ | ∘ | ∘ | ∘ | ∘ | ∘ |
| evaluation | | | | | | | | |

### Comparative Example 1

A polyethylene resin which contained only the component (B) and had low HLMFR/MFR and high tensile elongation was used for the tests as in Example 1. It was found that, as shown in Table 2, stress cracking resistance, flowability and breakage property of container closure bridges were poor in spite of preferable electron beam resistance.

### Comparative Example 2

A polyethylene resin which contained only the component (B) and had low HLMFR/MFR and high tensile elongation was used for the tests as in Example 1. It was found that, as shown in Table 2, stress cracking resistance, flowability and breakage property of container closure bridges were poor in spite of preferable electron beam resistance.

### Comparative Example 3

The tests were carried out in the similar manner as in Example 7 except that different resins were used for the components (A) and (B) as shown in Table 2. It was found that HLMFR and HLMFR/MFR were decreased and stress cracking resistance and flowability were poor in spite of preferable electron beam resistance.

### Comparative Example 4

The component (A) and the component (B) indicated in Table 2 were polymerized in the continuous two-reactor polymerization apparatus as in Example 1 followed by addition of the hindered amine compound indicated in Table 2 to obtain a polyethylene resin composition having a decreased flexural modulus compared to the range of the present invention. The obtained polyethylene resin composition had, as shown in Table 2, low density and rigidity in spite of preferable electron beam resistance. Due to low rigidity, the container closure was deformed.

### Comparative Example 5

The similar procedure was carried out as in Example 1 except that the hindered amine compound nor the phosphorous compound was added. It was found that, as shown in Table 2, electron beam resistance was poor.

### Comparative Example 6

The similar procedure was carried out as in Example 5 except that the hindered amine compound was not added. It was found that, as shown in Table 2, electron beam resistance was poor.

### Comparative Example 7

The similar procedure was carried out as in Example 9 except that the hindered amine compound was added at the amount of 0.001 parts by weight and the phosphorous compound was not added. It was found that, as shown in Table 2, electron beam resistance was poor.

### Comparative Example 8

The component (A) and the component (B) indicated in Table 2 were polymerized in the continuous two-reactor polymerization apparatus as in Example 1 and a polyethylene resin composition was obtained without addition of the hindered amine compound nor the phosphorous compound. The obtained polyethylene resin composition had, as shown in Table 2, low HLMFR and high HLMFR/MFR and thus had poor mouldability. The electron beam resistance was also poor.

TABLE 2

| | | | | Comparative Example | | | | | | | |
|---|---|---|---|---|---|---|---|---|---|---|---|
| | | | Unit | 1 | 2 | 3 | 4 | 5 | 6 | 7 | 8 |
| Polyeth- | Compo- | HLMFR | g/10 | — | — | 0.4 | 1.0 | 2 | 5 | 6 | 0.1 |
| ylene | nent (A) | | min | | | | | | | | |
| resin | | Density | g/cm3 | — | — | 0.937 | 0.920 | 0.942 | 0.937 | 0.938 | 0.942 |
| | | Comonomer | — | — | — | 1-butene | 1-butene | 1-butene | 1-butene | 1-butene | 1-butene |
| | | Weight ratio in | wt % | 0 | 0 | 8 | 22 | 21 | 22 | 26 | 25 |
| | | polyethylene | | | | | | | | | |
| | | resin | | | | | | | | | |
| | Compo- | MFR | g/10 | 4 | 20 | 20 | 330 | 200 | 60 | 280 | 300 |
| | nent (B) | | min | | | | | | | | |
| | | Density | g/cm3 | 0.963 | 0.962 | 0.961 | 0.970 | 0.970 | 0.970 | 0.972 | 0.967 |
| | | Weight ratio in | wt % | 100 | 100 | 92 | 78 | 79 | 78 | 74 | 75 |
| | | polyethylene | | | | | | | | | |
| | | resin | | | | | | | | | |

| Hindered amine | Type | — | Chimassorb | Chimassorb | Chimassorb | Tinuvin | — | — | Tinuvin | — |
|---|---|---|---|---|---|---|---|---|---|---|
| compound | | | 944 | 944 | 944 | 622 | | | 622 | |
| | Amount | parts | 0.05 | 0.05 | 0.15 | 0.05 | 0 | 0 | 0.001 | 0 |
| | relative to 100 | by | | | | | | | | |
| | wt parts of | weight | | | | | | | | |
| | polyethylene | | | | | | | | | |
| | resin | | | | | | | | | |
| Phosphorous | Type | — | Irgafos | Irgafos | — | — | — | — | — | — |
| compound | | | 168 | 168 | | | | | | |
| | Amount | parts | 0.05 | 0.05 | 0 | 0 | 0 | 0 | 0 | 0 |
| | relative to 100 | by | | | | | | | | |
| | wt parts of | weight | | | | | | | | |
| | polyethylene | | | | | | | | | |
| | resin | | | | | | | | | |
| Polyethylene resin | MFR | g/10 | 4 | 20 | 5 | 2 | 3.5 | 3.5 | 5.0 | 0.4 |
| composition and | | min | | | | | | | | |
| container closure | HLMFR | g/10 | 140 | 500 | 80 | 230 | 300 | 220 | 400 | 86 |
| prepared from | | min | | | | | | | | |
| the resin | HLMFR/MFR | — | 35 | 25 | 16 | 115 | 86 | 63 | 80 | 215 |
| composition | Density | g/cm3 | 0.963 | 0.962 | 0.963 | 0.955 | 0.963 | 0.960 | 0.960 | 0.961 |
| | Flexural | MPa | 1200 | 1100 | 1000 | 980 | 1100 | 1000 | 1000 | 1050 |
| | modulus | | | | | | | | | |
| | Constant | hour | 3 | 1 | 5 | 80 | 15 | 15 | 20 | 25 |
| | strain ESCR | | | | | | | | | |
| | Tensile | % | ≧400 | 200 | 80 | 55 | 60 | 58 | 42 | 70 |
| | elongation at | | | | | | | | | |
| | break | | | | | | | | | |
| | Melt | Pa · s | 480 | 220 | 520 | 340 | 320 | 350 | 280 | 360 |
| | viscosity | | | | | | | | | |
| | Hydrocarbon | ppm | 45 | 40 | 80 | 50 | 35 | 40 | 32 | 40 |
| | volatile | | | | | | | | | |
| | matter content | | | | | | | | | |
| | Coefficient | — | 0.22 | 0.22 | 0.30 | 0.38 | 0.19 | 0.21 | 0.22 | 0.22 |
| | of static | | | | | | | | | |
| | friction | | | | | | | | | |
| | Variation in | — | 1.9 | 1.7 | 1.8 | 1.8 | 2.1 | 2.1 | 2.1 | 2.1 |
| | chromaticity | | | | | | | | | |
| | (YI value) | | | | | | | | | |
| | after | | | | | | | | | |
| | irradiation | | | | | | | | | |
| | with electron | | | | | | | | | |
| | beams | | | | | | | | | |
| | Odour after | — | ∘ | ∘ | ∘ | ∘ | x | x | x | x |
| | irradiation | | | | | | | | | |
| | with electron | | | | | | | | | |
| | beams | | | | | | | | | |
| | Mouldability | — | x | x | x | ∘ | ∘ | ∘ | ∘ | x |
| | Breakage | — | Poor | Poor | Good | Good | Good | Good | Good | Good |
| | property of | | | | | | | | | |
| | container | | | | | | | | | |
| | closure | | | | | | | | | |
| | bridges | | | | | | | | | |
| | Container | — | ∘ | ∘ | ∘ | x | ∘ | ∘ | ∘ | ∘ |
| | closure shape | | | | | | | | | |
| | retention | | | | | | | | | |
| | capacity | | | | | | | | | |
| | Overall | — | x | x | x | x | x | x | x | x |
| | evaluation | | | | | | | | | |

Evaluation

It is apparent from the results shown in Table 1 that all the polyethylene resin compositions of Examples 1 to 14 fulfil the requirements according to the present invention and thus have preferable flexural modulus, stress cracking resistance (constant strain ESCR), mouldability (melt viscosity), breakage property of container closure bridges and container closure shape retention capacity and also have preferable electron beam resistance.

In contrast, the polyethylene resin compositions Comparative Examples 1 to 8 which did not either fulfil the type or the amount of the component (A) and/or the component (B) as defined in the present invention or contained no or a low amount of hindered amine compound had mouldability (melt viscosity), breakage property of container closure bridges, container closure shape retention capacity and electron beam resistance any of which was poor. The compositions of Comparative Examples 1 to 2 which contained the hindered amine compound and the phosphorous compound without component (A) had significantly impaired stress cracking resistance (constant strain ESCR). The compositions of Comparative Examples 5 to 8 which contained no or a low amount of hindered amine compound had significantly deteriorated variation (ΔYI) in chromaticity (YI value) before and after irradiation with electron beams and had strong odour.

### INDUSTRIAL APPLICABILITY

The polyethylene resin composition for container closures of the present invention can be used for moulding of closures for PET containers of liquid such as soft drink. The resin composition has excellent mouldability, has high flowability, has excellent balance between rigidity and impact resistance, has excellent stress cracking resistance, has excellent sliding property, has low odour, is harmless for food, has decreased elongation at high temperatures and is sterilizable by electron beam upon attachment thereof to a container, and thus is suitably used for container closures.

### REFERENCE SIGNS LIST

2: Container closure
4: top panel wall
6: Skirt wall
16: Breakage line
18: Main portion
20: Tamper-evident bottom portion
22: Slit
24: Bridge
30: Engaging means
32: Projection

1. A polyethylene resin composition, comprising 0.01 to 0.50 parts by weight of a hindered amine compound relative to 100 parts by weight of a polyethylene resin and having the following properties (a) to (f):
(a) a melt flow rate measured at a temperature of 190° C. under a load of 2.16 kg (MFR), of 0.5 to 10 g/10 min, a melt flow rate measured at a temperature of 190° C. under a load of 21.6 kg (HLMFR), of 100 to 500 g/10 min, and a HLMFR/MFR of 50 to 200;
(b) a density of 0.956 to 0.980 g/cm³;
(c) a flexural modulus of an injection moulding test specimen of 990 to 2000 MPa;
(d) a constant strain ESCR of an injection moulding test specimen of 10 to 400 hours;
(e) a tensile elongation at break of 190% or less; and
(f) a melt viscosity as measured on a capillary rheometer at 200° C. and a shear rate of 200 sec⁻¹ of 470 Pa·s or less.

2. The polyethylene resin composition according to claim 1, further having the following properties (g) to (i):
(g) a hydrocarbon volatile matter content of 100 ppm or less;
(h) a coefficient of static friction of 0.40 or less; and
(i) a variation (ΔYI) in chromaticity (YI value) of 2 or less before and after irradiating a sheet-shaped test specimen having a thickness of 2 mm with an electron beam at an absorbed dose of 30 kGy.

3. The polyethylene resin composition according to claim 1, wherein the hindered amine compound has a molecular weight of 500 or more.

4. The polyethylene resin composition according to claim 1, wherein the polyethylene resin comprises:
10 to 45% by weight of an ethylene polymer (A) having a HLMFR of 0.1 to 10 g/10 min and a density of 0.926 to 0.955 g/cm³; and
55 to 90% by weight (A+B=100% by weight) of an ethylene polymer (B) having a MFR of 25 g/10 min or more and a density of 0.961 to 0.980 g/cm³.

5. The polyethylene resin composition according to claim 1, further comprising 0.01 to 0.50 parts by weight of a phosphorous compound relative to 100 parts by weight of the polyethylene resin.

6. The polyethylene resin composition according to claim 1, wherein the hindered amine compound is poly[{6-(1,1,3,3-tetramethylbutyl)amino-1,3,5-triazine-2,4-diyl}{(2,2,6,6-tetramethyl-4-piperidyl)imino}hexamethylene{(2,2,6,6-tetramethyl-4-piperidyl)imino}]polycondensate, dimethyl succinate-1-(2-hydroxyethyl)-4-hydroxy-2,2,6,6-tetramethylpiperidine polycondensate, or both.

7. A container closure, which is moulded by the polyethylene resin composition according to claim 1.
